(19) United States
(12) Patent Application Publication
(10) Pub. No.: US 2008/0262397 A1
(43) Pub. Date: Oct. 23, 2008

(54) MASSAGING HEAD AND MOTORIZED ASSEMBLY COMPRISING SAME

(75) Inventor: Jacques HABATJOU, Cambrai (FR)

Correspondence Address: OBLON, SPIVAK, MCCLELLAND MAIER & NEUSTADT, P.C., 1940 DUKE STREET, ALEXANDRIA, VA, 22314, US

(73) Assignee: L'OREAL, Paris (FR)

(21) Appl. No.: 12/105,995

(22) Filed: Apr. 18, 2008

Related U.S. Application Data
(60) Provisional application No. 60/913,667, filed on Apr. 24, 2007.

(30) Foreign Application Priority Data
Apr. 18, 2007 (FR) 0754556

(51) Int. Cl. A61H 7/00

(52) U.S. Cl. 601/93; 601/134; 601/137; 601/89

(57) ABSTRACT

A massage assembly includes a motorized device having a drive arrangement configured to drive a massage head of the assembly. According to a preferred example, the massage head includes a plate provided with through openings and massage elements, each mounted in a through opening of the plate. The plate includes, around its perimeter, a relief for reversible mounting in the motorized device. The drive arrangement includes a rocker with a transmission surface against which the massage elements bear, with transmission surface oscillating about a pivot axis.

### CROSS-REFERENCE TO RELATED APPLICATIONS

This document claims priority to French Application Number 07 54556, filed Apr. 18, 2007 and U.S. Provisional Application No. 60/913,667, filed Apr. 24, 2007, the entire contents of both of which are hereby incorporated by reference.

### FIELD OF THE INVENTION

The invention relates to a massage head and a massage assembly comprising a massage head and a motorized device for driving at least one of the massage elements of the head. A preferred example applies depressive motion to a surface which is to be massaged. The invention can be advantageously used for massaging the skin, for example the face, the scalp, the neck and the legs.

### BACKGROUND OF THE INVENTION

### Discussion of Background

If massaging is performed before, during or after the application of a cosmetic product to the skin, it can help to promote its penetration into the skin. The expression “cosmetic product” here means a product as defined in Council Directive 93/35/EEC of 14 Jun. 1993.

Numerous devices for massaging the skin are known. For example, FR 1 126 798 discloses a massage head comprising studs projecting from a plate, with the plate being moved translationally by a cam driven by an electric motor. The problem with the teaching of that document is that it does not allow for interchangeability of massage heads. Furthermore, the studs are all moved simultaneously, and the massage effect is not optimal.

U.S. Pat. No. 5,159,922 discloses a massage device that limits the percussion delivered by the massage elements, with all the massage elements being driven with the same movement or else desynchronized relative to each other. This device also has the problem of inter-changeability of the massage elements.

U.S. Pat. No. 4,603,688 discloses a massage device configured to be mounted on the end of a water jet such that massaging balls in this device are moved about by the water jet.

EP 0 568 503, U.S. Pat. No. 1,579,679 and U.S. Pat. No. 1,635,917 disclose other massage devices having different structures, but all have the some or all of the same problems as those identified above. None of the known devices offers a solution for performing a massage by a percussive action that is gentle when the device is placed in contact with the skin. This constraint is more serious when the massage is being performed on the face or on other parts of the body where the blood vessels are very close to the surface of the skin.

### SUMMARY OF THE INVENTION

The subject of the invention is a massage assembly. An example of an embodiment includes a motorized device (3) comprising a drive means or drive arrangement configured to drive a massage head (2) of the assembly. The massage head includes a plate (4) provided with through openings (5) and massage elements (6), each mounted in a through opening of the plate. In one example, the plate includes around its perimeter a relief for its reversible mounting (19, 20) in the motorized device. The drive means or drive arrangement includes a rocker (22) with a transmission surface against which the massage elements bear, such that this transmission surface oscillates about a pivot axis (24).

It is thus easy to change the massage head, and therefore to modify the nature of the massage obtainable with a motorized device of this kind. According to a feature of a disclosed example, the changing of the massage head can be eased by the fact that functional fitting of the head is brought about in one motion because the massage elements can be pre-fitted and retained through the plate.

By way of example, the plate may advantageously be elastically deformable. In addition, the through openings can be sheathed internally to limit the friction with the massage elements. The internal dimensions of the through openings are preferably configured so as not to be excessively tight around the massage elements.

According to an example, the plate can include spring means or a spring arrangement configured to keep the massage elements in engagement with a transmission surface of the drive means. These spring means also help to attenuate the movements transmitted by the drive means. This feature allows an attenuated transmission of the movements of the drive means to the massage elements. The result is an effective, gentle massage that is particularly well received in sensitive areas such as the face.

According to a disclosed example, the spring means and the plate are advantageously unitary. For example, they may be produced as a single molding.

The spring means or spring arrangement can have portions in which through openings are formed so that each surrounds or is adjacent one massage element. These portions can each be connected to their immediate neighbors by connecting bands. Alternately, a spring could be common to two or more massage elements. The spring means for all of the massage elements together can advantageously be made as a single molding, for example.

By way of example, the application or massage elements may be of elongate form. They may advantageously be arranged parallel to each other. Alternatively or additionally they may be arranged in such a way as individually to project perpendicularly from an outer surface of the plate.

In the embodiments of the invention in which the plate is planar, preferably the outer surface is also advantageously planar.

By way of example, the application elements may be of cylindrico-ogival form, in which case they extend along a main length axis, and are preferably oriented relative to the plate and to the motorized device such that the tips formed by these various application elements are placed in contact with the skin.

The application elements can include a collar configured to engage with the perimeter of the respective opening formed in the plate, in order to prevent the elements from escaping, for example in a direction of translational movement. This collar is preferably formed at an axial end opposite to the end designed to come into contact with the surface to be massaged. Advantageously, if the device has spring means or spring device for example, each collar is configured to engage with a spring means.

The invention also relates to a massage assembly including a massage head according to the invention and a motorized device comprising a drive means or drive arrangement configured to drive the massage head, and in particular to drive the massage elements. According to a disclosed example, the drive means can include a rocker with a transmission surface against which the massage elements bear. The transmission surface may be planar, for example, with the ends of the massage elements which are in contact with the transmission surface preferably each having a planar surface facing it.

The transmission surface can oscillate about a pivot axis. This pivot axis may be situated at a distance from an edge of the massage surface. For example, if the massage surface (or massage head or plate) is circular, the pivot axis may be chosen to pass through the center (e.g., parallel with a diameter) of the massage surface. By way of example, the pivot axis may be parallel to a straight line defined as being perpendicular to the respective longitudinal axes of two massage elements. If so, the massage elements that are in contact with the transmission surface underneath the pivot axis are elements whose movement relative to the plate is less than that of those that are in contact with this same transmission surface but are situated at a distance from the pivot axis.

In a disclosed example, the pivot axis can be orthogonal to a straight line defined as being perpendicular to the respective longitudinal axes of two other massage elements of the device. With such an arrangement, these other two massage elements, which are in contact with the transmission surface at a distance from the pivot axis, are moved further and have a larger range or movement than the two previously described massage elements, relative to the plate.

Also, according to an example, the pivot axis can be orthogonal to a longitudinal axis of a handle of the device. This will simplify and reduce the number of parts necessary to produce the drive means. Alternatively, if the pivot axis is not orthogonal to a longitudinal axis of a handle of the device containing the motor, the device can include an angle drive with pinions or an elastic coupling.

For example, a rocker can include two diametrically opposite projections bearing on an inward flange of an outer shell of the motorized device. The rocker is thus retained within the outer shell. The profile of these two projections is preferably an arc of a circle designed to be in tangential contact with the inward flange. The tangential contact of these two projections is situated in the plane defined as being perpendicular to the transmission surface and passing through the pivot axis.

In one example of an embodiment of the invention, the drive means or drive assembly includes a motor, a transmission shaft rotated about an axis by the motor, with the rocker configured to oscillate about a pivot axis and including a cavity in which engages an eccentric end of the transmission shaft. The axis of rotation of the transmission shaft intersects the pivot axis, such that the driving of the transmission shaft causes the rocker to oscillate between two angular positions, so that the massage elements are moved through their openings as a function of their angular location relative to the pivot axis.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

A better understanding of the invention will be gained from reading the following description in conjunction with the accompanying figures. The figures are offered purely as a guide and by way of example, and in no way limit the invention.

FIG. 1 is a view in longitudinal section of an example of an assembly according to the invention;

FIG. 2 is a view in longitudinal section of an example of an assembly according to the invention, taken on a cutting plane perpendicular to the cutting plane of FIG. 1;

FIG. 3 is a profile view showing the positions of the massage elements, which depend on the position of the transmission surface in an assembly according to an example of the invention; and

FIG. 4 is a partial view of a drive device for an example of an assembly according to the invention.

### DETAILED DESCRIPTION OF THE PREFERRED EMBODIMENTS

Referring now to the drawings, like reference numerals are utilized to designate identical or corresponding parts throughout the several views.

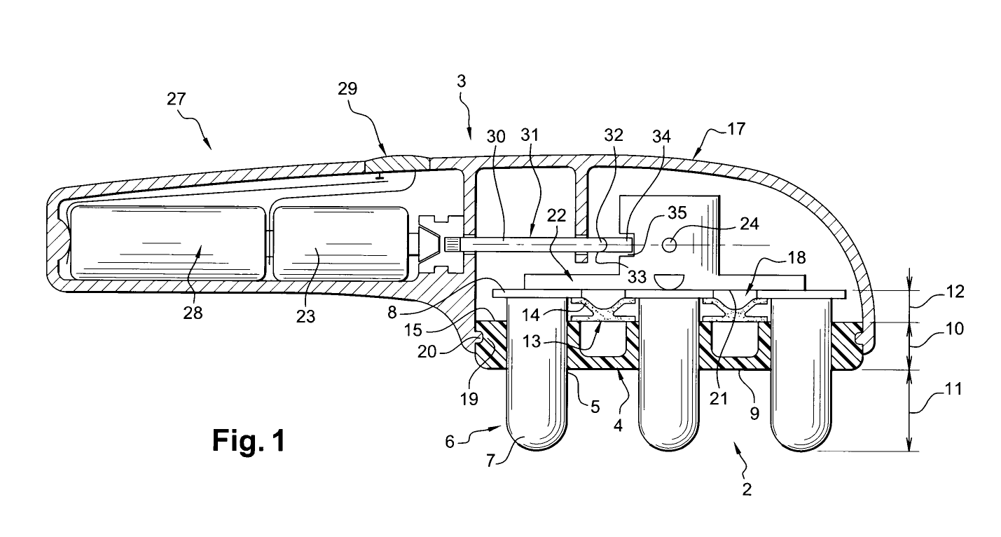

FIG. 1 shows a massage assembly 1 fitted with a massage head 2 according to an example of the invention fitted to a motorized device 3 for driving the massage head.

In the illustrated example, the massage head 2 includes a plate 4 containing at least one opening 5 through which extends at least one massage element 6.

The plate 4 can be made of a thermoplastic, for example from acrylic, cellulose, polycarbonate, polyamide, styrene, polyolefin, vinyl or polyethylene terephthalate compounds and/or blends in variable proportions of these compounds, expanded or otherwise. The plate can also be made of a thermoplastic resin, or of metal, or from a multilayer material, or from fibers, such as synthetic fibers. Also by way of example, the plate can be sintered.

In the illustrated example, the massage head 2 advantageously includes at least two identical massage elements, each mounted in an opening and the plate having one opening for each massage element. By way of example, the massage elements have a metallic outer surface. They may be produced in plastic, with for example a metallized surface. They can also be made from a thermoplastic, for example from acrylic, cellulose, polycarbonate, polyamide, styrene, polyolefin, vinyl or polyethylene terephthalate compounds and/or blends in variable proportions of these compounds, expanded or otherwise. The massage elements may also be made of a thermoplastic resin, or of metal, or from a multilayer material, or from fibers, such as synthetic fibers. The massage elements may be produced by sintering.

As a variant, the massage elements of one massage head can be different from each other, in which case the openings are each made in the appropriate dimensions to fit the outer perimeter of a massage element, in such a way as to allow translational movement of the massage element through its opening.

The smallest internal cross section of the opening is however smaller than the greatest external cross section of the massage element (at least with respect to the portion of the massage element which passes through the opening). The reason for this is that the massage element 6 has a first end 7 which is designed to be placed against the surface that is to be massaged, and a second end 8 opposite the first. Between the first and second ends, preferably near the second end or even at this second end 8, is the greatest external cross section of the massage element. There is thus a single direction of insertion of the massage element 6 through its opening 5 in the illustrated example. In addition, this cross section allows the massage element 6 to be retained on the plate 4 when the massage element 2 is mounted in the motorized device 3, this greatest external cross section being in this case situated between the plate 4 and the motorized device 3.

The configuration of the massage element 6 is such as to limit its translational movement through its opening 5. At the same time, the plate 4 is also configured to ensure a sliding-friction contact of the plate around each massage element in each opening 5 so as to provide a coefficient of friction that will attenuate the movement of the massage elements relative to the plate 4.

The first end 7 is of for example cylindrico-ogival form, while the second end 8 is of annular collar form. In the example illustrated, all the massage elements such as 6 are identical with each other.

The plate 4 has an outer surface 9 from which the massage elements project. This outer surface 9 is smooth. As a variant, it may have surface irregularities to assist massaging. In the example illustrated, this outer surface is defined in a plane and the massage elements fitted parallel to each other, at right angles to this plane.

Further by way of example, the massage heads according to the invention can include plates having a non-planar—e.g. domed—surface, and massage elements that are not necessarily parallel to each other. They may for example extend radially relative to the outer surface of the plate in which they are mounted.

The plate 4 in the illustrated example has a variable thickness, seen in a transverse cutting plane, perpendicular to the outer face 9. In particular, the plate 4 has a maximum thickness 10 around the openings 5.

At rest, the massage elements 6 project out to a height 11 from the outer surface 9, and project in to a height 12 from an inner surface 15. This height 12 may for example be greater than the thickness of the collar 8. To maintain this height 12, the massage head according to the illustrated example of the invention comprises one or more springs or spring means 13. In the illustrated example, the spring means or spring arrangements 13 include for each massage element an elastically deformable prong 14 which presses between the collar 8 and the inner surface 15 of the plate 4.

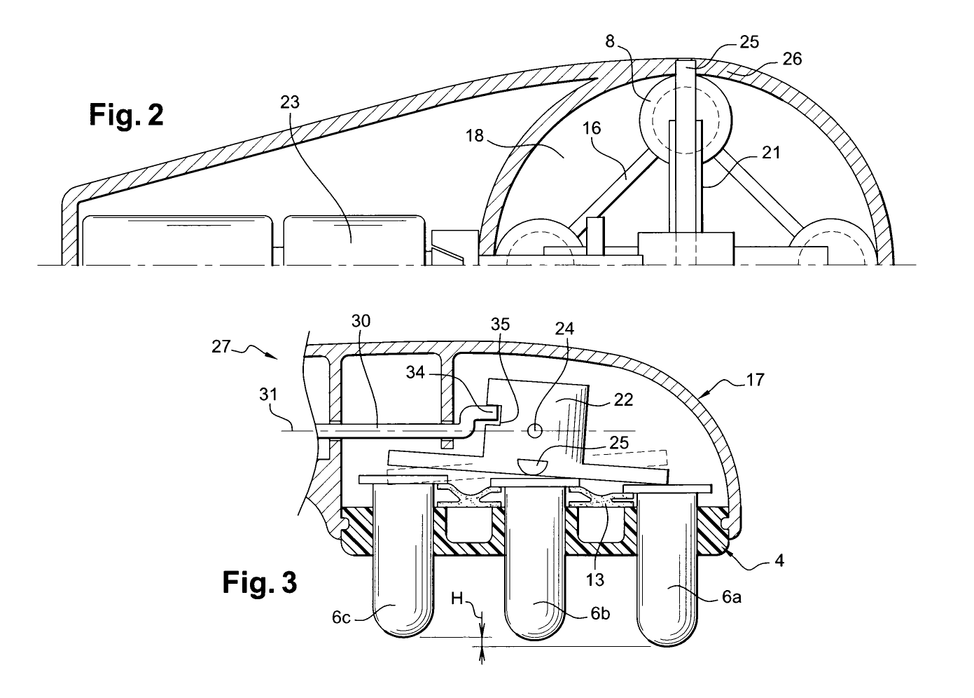

The springs or spring means 13 can be independent of each other, or they may each be connected to their neighbors by flexible prongs 16, as shown in FIG. 2. The springs can be provided adjacent the openings in the plate and adjacent the massage elements, they may additionally be arranged so as to surround the openings if desired.

The spring means 13 are in this example attached to the inner surface 15 of the plate 4. They may be fixed permanently to the plate, if for example they are produced as an overmolding, or as a one-piece molding, or if they are bonded adhesively together.

The massage head 2 is mounted detachably in a shell 17 of the motorized drive device 3 in the illustrated example. The shell 17 has an opening 18 to accommodate the plate 4. For example, the plate 4 may have an annular groove 19 around its edge configured so as to snap onto an annular bead 20 projecting radially into the opening 18. The massage head 2 is mounted in this shell 17 in such a way that the ends such as 8 of the massage elements are arranged against a transmission surface 21 of a rocker 22 of the device 3.

As a variant example of the annular groove 19, the relief formed around the edge of the plate 4 to allow a reversible fitting may be a pin designed to be engaged in a bayonet slot in the inside perimeter of the shell 17. In another variant example of a relief, the plate 4 may have projection or other means for snapping onto the outer perimeter of the shell 17. The reversible fitting of the plate 4 may alternatively be obtained by a screwthread, for example.

To reduce the weight of such an assembly 1, the rocker 22 may be so designed that the transmission surface is a single surface but is limited to the area necessary to press against each of the massage elements. For example, as shown in FIG. 2, the transmission surface 21 is cross-shaped so that the ends of the arms of the cross individually press on each of the four massage elements provided in the massage head.

In this example, the fitting of the massage head, even if it is circular, is performed with the aid of a position marker to ensure that each of the massage elements makes good contact with the transmission surface 21.

Since the massage head 3 is easy to fit into the shell 17, it is also easy to remove it, whether for cleaning purposes or to replace it with another massage head having different massage elements or a different arrangement of massage elements.

The springs or spring means 13 press or bias the ends 8 of the massaging elements against the transmission surface 21 so that the movements of the rocker 22 are transmitted to the massaging elements 6.

The transmission surface 21 is approximately planar in the illustrated example. The plate 4 is preferably mounted in the shell 17 in such a way that the massage elements extend at right angles to the transmission surface 21. The transmission surface 21 may have surface irregularities to convert the movement of the rocker into more complex movements of the massage elements.

The rocker 22 is driven by a motor 23 in such a way as to oscillate about a pivot axis 24. Specifically, the rocker 22 is pivoted in such a way as to cause the transmission surface 21 to oscillate between two angular positions relative to a planar surface. This planar surface is approximately parallel to the plane of the plate 4 when the latter is not under any stress in the motorized device 3.

The rocker 22 bears against an inward flange of the shell 17 at two diametrically opposite bearing points such as 25. In FIG. 2, half of the rocker is shown, and one bearing point 25 is shown bearing on a flat annular surface 26 defined within the shell 17. The bearings points such as 25 are preferably situated on a straight line parallel to the pivot axis 24.

In FIG. 3, the cross section of one of the bearing points 25 is shown. The bearing point 25 designed to push against the flat surface 26 has a curvature so as to press tangentially against the flat surface in all angular positions of the rocker 22. This curvature enables the transmission surface 21 to be moved continuously from one angular position to another, without shocks.

With each oscillation, the transmission surface 21 is pivoted about the pivot axis 24 so that this movement is transmitted to the massage elements. The massage elements are therefore principally constrained to execute a movement with a single component corresponding to the axis of the opening through which they are respectively inserted. Depending on the angular position of the transmission surface 21 and the position of the massage elements relative to the pivot axis, the springs or spring means 13 are stressed individually, and the massage elements are moved individually.

If the plate 4 is elastically deformable, the stress applied by the rocker 22 may lead to local deformations of the plate 4, and in practice to an increase of the movement transmitted to the massage elements.

The pivot axis 24 is orthogonal to the main length axes of the massage elements in the example shown in FIG. 1. This pivot axis 24 is parallel to the transmission surface 21. The pivot axis 24 is orthogonal to a main length axis of the assembly 1. In particular, the assembly 1 includes a handle 27 to which the pivot axis 24 is orthogonal. In this way the assembly can be used to massage by successive pressure on the skin along an axis parallel to the axis of the handle. Such an assembly becomes intuitive to operate and the user can thus control the direction of the massage, and thus stimulate the skin in a preferred direction.

The motor 23 is preferably housed inside the handle 27. The motor is connected to an electric power source 28, including for example (as shown) of a rectangular 9V battery. In the example illustrated, the electric power source 28 is also housed in the handle. In a variant (not shown) the electric power source 28 is rechargeable and can be recharged by for example placing the assembly 1 on a cradle. In another variant (not shown), the 9V battery is replaced by at least two 1.5V AA batteries side by side, for example.

Advantageously, the assembly 1 is provided with a switch 29 so that the motor 23 can be powered or not powered as desired. A pushbutton for the switch 29 is preferably located on the outside of the handle 27. The switch 29 may be one that stays depressed, in other words only needs to be actuated once for it to remain in position. Alternatively, the switch 29 may be dependent on permanent external actuation. In this case the motor 23 receives power only when manual pressure is maintained on the switch 29.

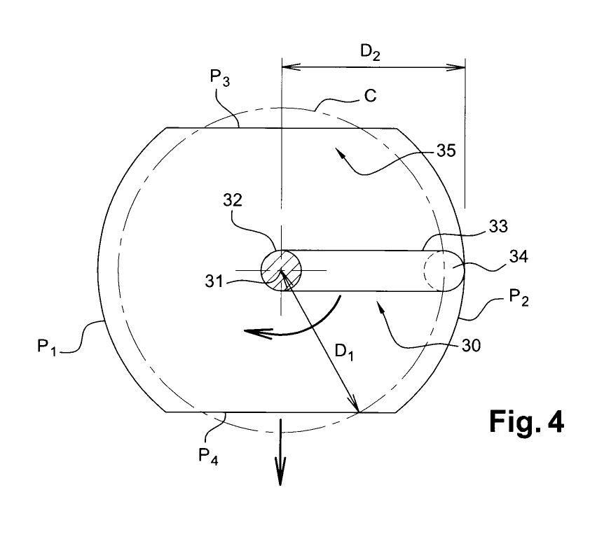

The motor 23 turns a transmission shaft 30 about an axis of rotation 31. The axis of rotation 31 is perpendicular to the pivot axis 24. The transmission shaft 30 is not straight: it has two 90° bends 32 and 33, so that the free end 34 of the transmission shaft 30 extends parallel to and at a distance from the axis of rotation 31. This free end 34 intersects the pivot axis 24 in only two angular positions 180° apart from each other, as shown in FIG. 1. When the transmission shaft 30 rotates, the free end 34 is also turned and describes the perimeter of a circle C shown in FIG. 4.

The free end 34 of the transmission shaft 30 is engaged in a cavity 35 formed in the rocker 22. The cavity 35 is configured such that the rotation of the free end 34 is converted into an alternating oscillating movement of the rocker 22. FIG. 4 shows the perimeter of the cavity 35. This perimeter of the cavity 35 is not circular. It has in this illustrative embodiment an axis of symmetry passing through the axis of rotation 31, when it is not displaced by the transmission shaft 30. It has two opposite curved portions P1 and P2 connected together by two straight segments P3 and P4. The segments P3 and P4 are parallel to the pivot axis 24.

The distance D1 between the axis of rotation 31 and any point on these straight segments P3 and P4 is less than the distance D2 between this axis of rotation and the free end 34. The rocker is made of a nondeformable material, so that when the free end 34 contacts one of these segments P3 or P4, it causes the rocker to pivot about the pivot axis 24.

By modifying the perimeter of the cavity 35, the form of movement transmitted to the rocker 22 by the motor 23 can thus be modified.

The motorized device can include reducing gears to gear down the force developed by the motor 23 and reduce the speed of rotation of the transmission shaft 30 and thus slow the speed of the oscillations of the rocker 22. The motorized device 3 can include a controller of the frequency of rotation of the motor 23 to allow the user to choose between gentler or more stimulating types of massage.

To prevent the vibrations of the motor 23 being transmitted to the handle 27, the motor 23 may be retained by an elastically deformable member arranged radially around the body of the motor 23 to bear radially against the inner wall of the handle. This elastically deformable member is configured to absorb the vibrations.

In FIG. 3, the positions of the massage elements 6 are shown for an angular position of the rocker 22. When the rocker is tilted forwards relative to the handle 27, the massage element 6a nearest the front of the assembly 1, relative to the long axis of the handle, is moved translationally and projects beyond the massage elements 6b and 6c by a height H. The dashes show a second angular position of the rocker 22 in which the massage element 6a is returned to the same level as the central massage element 6b by its spring or spring means 13, while massage element 6c in this same position projects beyond the other two massage elements by the same height H.

The invention allows the use of the massage assembly before and/or after the application of a cosmetic product on the surface to be massaged, to promote its cosmetic action.

Throughout the description expressions such as “comprising” “having” “including” or “has” should be interpreted as synonymous with “comprising at least one”, unless otherwise stated. Similarly, expressions such as “comprising two” should be interpreted as meaning “at least two” unless otherwise stated.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A massage assembly comprising:
a massage head;
a motorized device comprising a drive means configured to drive the massage head of the assembly;
the massage head comprising a plate provided with through openings and massage elements each mounted in a through opening of the plate, wherein the plate comprises around its perimeter a relief for reversible mounting in the motorized device; and
wherein the drive means comprises a rocker with a transmission surface against which the massage elements bear, and wherein the transmission surface oscillates about a pivot axis.

2. An assembly according to claim 1, wherein the plate is elastically deformable.

3. An assembly according to claim 2, wherein the massage elements are mounted so as to slide in their respective through openings, and wherein the openings are internally sheathed to limit friction with the massage elements.

4. An assembly according to claim 1, wherein the plate comprises spring means configured to maintain the massage elements in engagement with a transmission surface of the drive means.

5. An assembly according to claim 4, wherein the spring means each have portions adjacent one massage element, and wherein the portions are each connected to their immediate neighbors by connecting bands.

6. An assembly according to claim 1, wherein the massage elements are elongated and are arranged parallel to each other, and wherein the application elements extend perpendicularly from the plate.

7. An assembly according to claim 1, wherein the plate is planar.

8. An assembly according to claim 1, wherein the massage elements have a cylindrico-ogival shape.

9. An assembly according to claim 1, wherein the massage elements comprise a collar which extends beyond a perimeter of the respective opening formed in the plate, in order to prevent the elements from escaping in a direction through the plate.

10. An assembly according to claim 1, wherein the pivot axis is parallel to a straight line which is perpendicular to respective longitudinal axes of two massage elements.

11. An assembly according to claim 10, wherein the pivot axis is orthogonal to a second straight line which is perpendicular to respective longitudinal axes of two other massage elements of the device.

12. An assembly according to claim 1, wherein the pivot axis is orthogonal to a straight line which is perpendicular to respective longitudinal axes of two massage elements.

13. An assembly according to claim 1, wherein the pivot axis is orthogonal to a longitudinal axis of a handle of the device.

14. An assembly according to claim 1, wherein the rocker comprises two diametrically opposite projections bearing on an inward flange of an outer shell of the motorized device.

15. An assembly according to claim 1, wherein the drive means comprises a motor and a transmission shaft rotated about an axis by the motor, wherein the rocker is configured to oscillate about the pivot axis and the rocker includes a cavity in which engages an eccentric end of the transmission shaft, and wherein the axis of rotation of the transmission shaft intersects the pivot axis such that driving of the transmission shaft causes the rocker to oscillate between two angular positions, so that the massage elements are individually moved through their openings as a function of the oscillation of the rocker and the position of the massage elements relative to the pivot axis.

16. An assembly according to claim 1, wherein massage elements located at a greater distance from said pivot axis have a greater range of movement than one or more massage elements located closer to the pivot axis.

17. An assembly according to claim 1, wherein the drive means comprises a motor which drives a shaft about a shaft axis, and wherein the shaft includes an eccentric end which engages said rocker to cause the rocker to pivot about the pivot axis.

18. An assembly according to claim 17, wherein said shaft axis is orthogonal to said pivot axis.
